(19) United States
(12) Patent Application Publication
(10) Pub. No.: US 2019/0289089 A1
(43) Pub. Date: Sep. 19, 2019

(54) System and Method for Digital Content Subscription by Geographical Area

(71) Applicant: Jong Shyr Huang, Redmond, WA (US)

(72) Inventor: Jong Shyr Huang, Redmond, WA (US)

(21) Appl. No.: 15/922,150

(22) Filed: Mar. 15, 2018

(51) Int. Cl. H04L 29/08; H04W 4/021

(52) U.S. Cl. CPC H04L 67/26; H04W 4/021

(57) ABSTRACT

A method and system are provided for subscribing to digital content within a subscription area. A subscriber mainly describes the document types, categories of information of interest, and a subscription area indicated by a circle or polygon on a map. All matching publications within the subscription area will be presented to the subscriber upon opening a subscription. As new publications are added within a subscriber's subscription area, the subscriber will automatically receive the new publications without adding each publication one by one. From a publisher's standpoint, the invention allows a publisher to send digital content to subscribers either in real-time or on-demand according to subscription areas. It is an effective method for information dissemination by locations, which is applicable to various document types such as notices, alerts, events, sales advertising, blogs, and news.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The present invention relates to techniques for publisher and subscriber creation, automatic discovery of publications, and consumption of publications using hand-held devices with Global Positioning System (GPS) and Internet connection.

### BACKGROUND OF THE INVENTION

A publisher is anyone with information to disseminate. Examples of information to disseminate are news, advertising, public notice, events, blogs, . . . , etc. A subscriber is anyone who wants to receive information from one or more publishers. A publisher publishes or broadcasts a collection of information called publication. A subscriber reads or receives a collection of information called subscription.

Currently, there are different ways for a subscriber to subscribe information of interest. For example, in newspaper or magazine model, a subscriber signs up for specific publications of interest either offline or online. The publication can be delivered either in physical or digital copies. Another example is the Facebook and Twitter's follower model where a person (follower) can choose people or topics to follow. Information of the followed people or topics will then be presented to the followers automatically.

This invention aims to enable a publisher and subscriber model based on geographic locations. A publisher indicates on a map where its publication will be published. A subscriber can then subscribe publications based on a geographic area indicated on a map. There is no need for a subscriber to subscribe to any specific publication. Any new publications within the desired subscription area by a subscriber will be made available automatically. Thus, this invention allows a subscriber to know information of interest within a geographic boundary. This invention also allows a publisher to publish content that is related to certain geographic location to all subscribers in real-time.

With the advent of smart phones, tablets, and mobile devices, capturing digital content such as images, videos, and sound via built-in camera and microphone becomes easy. Furthermore, with built-in GPS, the device knows our geographic location. As a result, every image, video, and sound captured by smart phones and similar devices already contain GPS locations. A smart phone or a similarly equipped device now becomes a very efficient tool for digital content acquisition and creation. In this invention, a publisher can create documents that contain text, audio, videos, and photos with a smart phone equipped with GPS and Internet connection. The documents created will be tagged with GPS locations.

Modern databases such as MongoDB, SQL, and Elasticsearch provide content store capabilities to store, index, and retrieve digital content. They can not only index digital content by text but also by geographic locations represented by longitude and latitude. Furthermore, these modern databases allow spatial searches where digital content can be filtered by a bounding polygon or circle. An embodiment of this invention contains a content store for storing and retrieving digital content and a separate content index store for indexing and searching of digital content by bounding geographical area represented by wither a polygon or circle.

An embodiment of this invention uses a map service such as Google map or Apple map service to allow a publisher to create a publication on a map with a mobile device. The location where a publication icon is drawn on the map indicates the publishing location of the publication. Similarly, an embodiment of this invention allows a subscriber to draw a subscription area, either a circle or polygon, on a map with a mobile device. This subscription area determines which publications will be included for the subscriber. All new subscriptions added within the subscription area will be automatically added to the subscription.

An embodiment of this invention uses push notification service provided by companies such as Apple, and Google. The push notification service allows real-time notifications to be sent to subscribers to notify them of new content from their subscribed publications.

### SUMMARY OF THE INVENTION

In one aspect, this invention includes a smart phone or similar mobile device that is equipped with Internet data service, and Global Positioning System (GPS.) The smart phone or similar mobile device contains a user application that allows the user to create publication and subscription on a map based on GPS location. The system also includes an Internet-based Application Programming Interface (API) layer that provides the service endpoints for the user-application running on the smart phone or similar mobile device. Behind the API layer is the content store for storing publisher and subscriber documents; a content index store for indexing publication and subscription related text content and locations for querying. Other than the user application, all the other components constitute server components that reside in the cloud.

In another aspect, this invention includes a user application running on a smart phone or similar mobile device. The user application allows publishers to create publications on a map. Each publication is indicated by a graphical icon on the map at its publishing location. Each publication on the map represents a source of information to disseminate with a GPS location. When a publisher is ready to publish, all he or she must do is to touch the publication icon on the map and create a new document of certain type and category. The document of that type and category will then be available for subscribers who subscribe to this type and category of information.

In yet another aspect, the user application also allows subscribers to create subscription on a map. Each subscription is indicated by a graphical icon on the map at its subscribing location. In addition, the user application allows a subscriber to define a subscription area. The subscription area can be a polygon or circle and it can be anywhere on the map regardless where the subscriber is. Furthermore, the user application allows the subscriber to specify how subscriptions should be delivered. A subscription can be delivered either in real-time or on-demand.

In an additional aspect, this invention includes a user application running on a smart phone or similar mobile device. The application allows subscribers to consume subscriptions on demand. A subscriber simply selects a subscription to read in the user application. Any information of interest that was disseminated within the subscription area since the subscriber's last visit will be presented to the subscriber when the subscriber touches the subscription icon on the map.

In a further aspect, this invention includes an application running on a smart phone or similar mobile device. The application allows subscribers to consume subscriptions in real- time. As new information is disseminated from publications within a subscriber's subscription area, that information is sent to the subscriber via push notifications immediately. For every new piece of information published, all subscribers will receive real-time notification via the user application.

### BRIEF DESCRIPTION OF THE DRAWINGS

The present invention is described in detail below with references to the attached drawing figures, wherein:

FIG. 1 is an exemplary block diagram showing an embodiment of the invention;

FIG. 2 is an exemplary map showing the relationship between subscriptions and publications.

FIG. 3 is an exemplary block diagram of data flow of publication, subscription, and real-time notification service within the invention;

### DETAILED DESCRIPTION OF THE INVENTION

The invention relates to a system for subscribing to publications located in a subscriber-defined geographic area using hand-held devices with GPS and Internet connection.

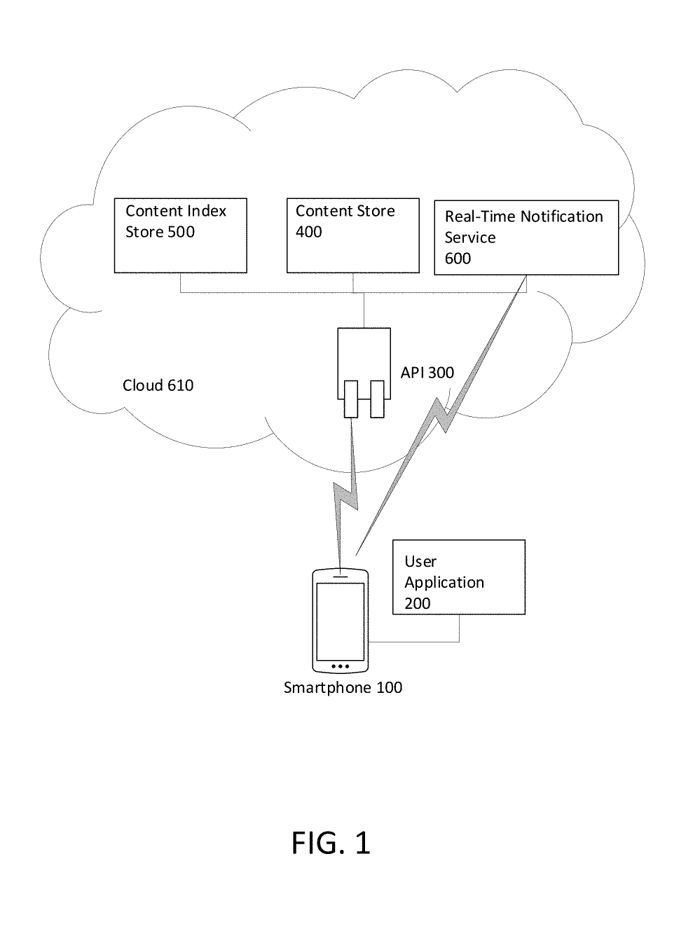

FIG. 1 illustrates an embodiment for enabling the invention. Users of this invention will need a mobile device, such as a smartphone 100 with built-in Global Positioning System (GPS), Wi-Fi and Internet connection. The use of GPS and Wi-Fi capabilities is to allow the latitude and longitude of the device to be detected. On this smartphone 100, there is a User Application 200 that allows a multitude of actions by the user. Internet connection is required for User Application 200 to communicate with the servers residing in the cloud 610 provided by cloud service provider such as Amazon, Google or Microsoft. All data generated by the User Application 200 are sent to the servers in the cloud 610 via the Application Programming Interface (API) 300 residing on a web server. All these data will be stored at the Content Store 400. In addition, selected portion of the user-generated data will be indexed by the Content Index Store 500. All queries from the User Application 200 will be done through the API 300 and directed to the Content Index Store 500. Subscription can be delivered to the subscriber in two ways: real-time and on-demand. In real-time delivery, published content will be broadcast to its subscribers via Real-time Notification Service 600. In on-demand delivery, the User Application 200 queries the Content Index Store 500 via API 300 for subscribed content.

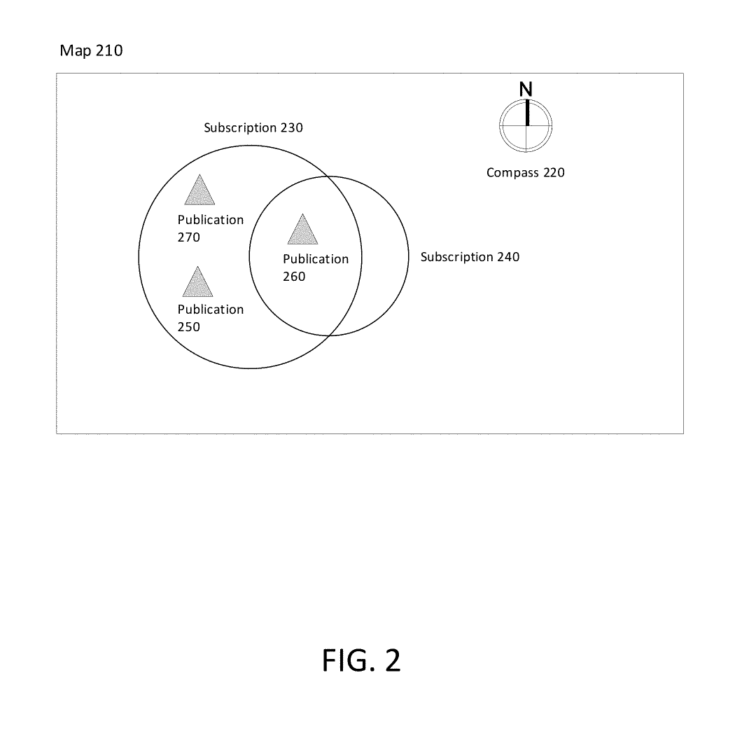

FIG. 2 shows an embodiment of the invention where Subscription 230 and Subscription 240 are indicated on a Map 210 by their respective subscription area. A subscription area can be a circle or polygon even though circle was used in this exemplary embodiment. Compass 220 indicates north on Map 210. A subscriber creates a subscription area on the map to subscribe to all publications within the subscription area. A publisher creates a publication on the map to indicate the publishing location. There are three exemplary publications created on the map in FIG. 2: Publication 250, Publication 260, and Publication 270. Any new information published for Publication 260 will be made available for both Subscription 230 and Subscription 240 since both subscriptions include Publication 260 in their subscription areas. Similarly, any new information published for Publication 250 and Publication 270 will only be available for Subscription 230, which is the only subscription with subscription area enclosing both publications.

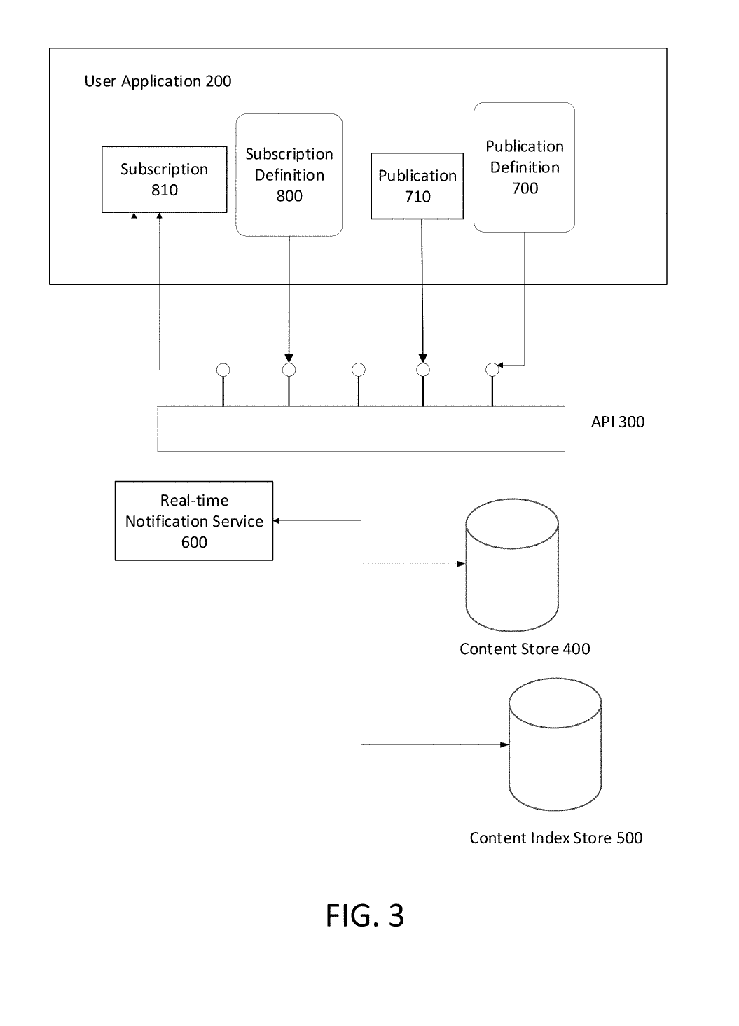

FIG. 3 illustrates data flow of this invention. The process of creating either publications or subscriptions starts from the User Application 200. A publisher can use the User Application 200 to create a Publication Definition 700, which is structured information that contains data such as publisher name, publication name, security access rules, and publication GPS location Likewise, a subscriber can use the User Application 200 to create a Subscription Definition 800, which is also structured information that contains data such as subscription name, subscribed content types and categories, subscriber phone number, and subscription area represented by a polygon or circle. All publication and subscription definitions created will be sent to the API 300, which will then store the definitions at the Content Store 400. At the same time, all text content and GPS locations are sent to the Content Index Store 500 to index so that we can search content by both text and geographic locations.

In reference to FIG. 3, when it is time to publish (broadcast) new content, a publisher can use the User Application 200 to select the Publication 710 corresponding to a Publication definition 700. A Publication 710 allows a publisher to create new document, which may contain text, audios, pictures, and videos, remove published document, or modify published document. All new documents created for a Publication 710 will share the same GPS location as specified in its Publisher Definition 700. A published document will be sent to the API 300, which in turn saves the document to the Content Store 400. At the same time, API 300 will send the document types, categories, keywords, and GPS location of the published document to the Content Index Store 500 for indexing. As soon as indexing operation is done on the newly published document, Real Time Notification System 600 will find all subscriptions with subscription areas containing the GPS location of the published document and send out real-time notifications to all relevant subscribers. The User Application 200 will present the real-time notification to the subscriber about the newly published document. Alternatively, a subscriber can select the Subscription 810 defined by the Subscription Definition 800 to read new content of a subscription on demand. Upon opening a Subscription 810 on the User Application 200, a request will be sent to the API 300, which in turn queries the Content Index Store 500 for all published documents within a subscription area with the desired document types and categories as defined in the Subscription Definition 800.

I claim:

1. A system for subscribing digital content based on a geographic area on a map, the system comprising: a content store for storing digital content, publication definitions, and subscription definitions; and
a content index store for indexing digital content by GPS location, document types, categories, and other searchable text fields; and
a real-time notification service to send real-time notifications to subscribers upon receiving new content; and
a web server with an Application Programming Interface (API) layer for handling requests coming from the user application; and
a user application which runs on a mobile device with GPS, and Internet connection.

2. The system of claim 1, wherein the user application facilitates the creation of publication definition, which is tagged with GPS location.

3. The system of claim 1, wherein the user application facilitates the creation of subscription definition, which contains a subscription area indicated by a circle or a polygon on a map.

4. The system of claim 2, wherein all publications and published content will be indexed by a content index store on GPS location to enable searching for publications within a subscription area.

5. The system of claim 2, wherein the user application allows a publisher to add new documents to a Publication, which will notify all subscribers of the new document in real-time via real-time notifications service.

6. The system of claim 2, wherein the user application allows a publisher to remove published document from a publication, and modify published document in a publication.

7. The system of claim 3, wherein a new publication is automatically included in a subscription if the new publication falls within the subscription area defined in the subscription definition.

8. The system of claim 3, wherein the user application allows a subscriber to read new content in a subscription on-demand.

9. The system of claim 3, wherein the user application allows a subscriber to read new content in a subscription in real-time.
